(19) United States
(12) Patent Application Publication
(10) Pub. No.: US 2025/0251684 A1
(43) Pub. Date: Aug. 7, 2025

(54) SHEET TYPE DETERMINATION DEVICE, IMAGE FORMING SYSTEM, AND RECORDING MEDIUM

(71) Applicant: Konica Minolta, Inc., Tokyo (JP)

(72) Inventors: Hitoshi ASANO, Toyokawa-shi (JP); Yumiko IZUMIYA, Tokyo (JP)

(21) Appl. No.: 19/039,882

(22) Filed: Jan. 29, 2025

(30) Foreign Application Priority Data
Feb. 2, 2024 (JP) 2024-014659

(51) Int. Cl. G03G 15/00; G03G 15/16; G03G 15/20

(52) U.S. Cl. CPC G03G 15/5029; G03G 15/1675; G03G 15/2039; G03G 2215/00738; G03G 2215/00742; G03G 2215/00751; G03G 2215/00776

(57) ABSTRACT

Disclosed is a sheet type determination device for determining a sheet type, including a hardware processor that determines whether a sheet is synthetic paper based on a detection result of a moisture sensor configured to detect characteristic information corresponding to a moisture amount of the sheet.

### CROSS REFERENCE TO RELATED APPLICATIONS

The present invention claims priority under 35 U.S.C. § 119 to Japanese Application No. 2024-014659 filed on Feb. 2, 2024, the entire contents of which being incorporated herein by reference.

### BACKGROUND OF THE INVENTION

### Technical Field

The present invention relates to a sheet type determination device, an image forming system, and a recording medium.

### Description of Related Art

In the related art, a sensor device that determines the type and characteristics of a sheet based on optical characteristics (ratio of a signal level of surface specular reflection light to a signal level of internal diffuse reflection light) and electrical characteristics (volume resistivity) of the sheet is disclosed (see JP 2018-44929A).

### SUMMARY OF THE INVENTION

However, in the sensor device disclosed in JP 2018-44929A, as illustrated in FIG. 7, the resistance value of common paper (paper mainly made of pulp fiber) in a low humidity environment is as high as that of synthetic paper, which can lead to misidentification between synthetic paper and common paper. In the example of FIG. 7, each paper of the basis weight 407 g/m², 300 g/m², 160 g/m², 85 g/m² corresponds to the above common paper, and the synthetic paper A and the synthetic paper B correspond to the above synthetic paper.

The present invention has been made in view of the above problem, and objects of the present invention include accurately distinguishing between synthetic paper and common paper.

To achieve at least one of the abovementioned objects, a sheet type determination device reflecting one aspect of the present invention comprises a hardware processor that determines whether a sheet is synthetic paper based on a detection result of a moisture sensor configured to detect characteristic information corresponding to a moisture amount of the sheet.

To achieve at least one of the abovementioned objects, a non-transitory recording medium reflecting another aspect of the present invention stores a computer-readable program, the program causing a computer to determine whether a sheet is synthetic paper based on a detection result of a moisture sensor configured to detect characteristic information corresponding to a moisture amount of the sheet.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image forming system according to the present embodiment;

FIG. 2 is a block diagram illustrating a main functional configuration of the image forming system according to the present embodiment;

FIG. 3 is a flowchart illustrating a flow of process condition setting processing;

FIG. 4 is a flowchart illustrating a flow of sheet type determination processing;

FIG. 5 is a graph illustrating an example of a second threshold value (threshold value for determining synthetic paper);

FIG. 6 is a graph illustrating another example of the second threshold value (threshold value for determining synthetic paper); and

FIG. 7 is a graph illustrating a relationship between environmental humidity and resistance value for common paper and synthetic paper.

### DETAILED DESCRIPTION

Hereinafter, one or more embodiments of an image forming system according to the present invention will be described with reference to the drawings. However, the scope of the invention is not limited to the disclosed embodiments.

[1. Configuration of Image Forming System]

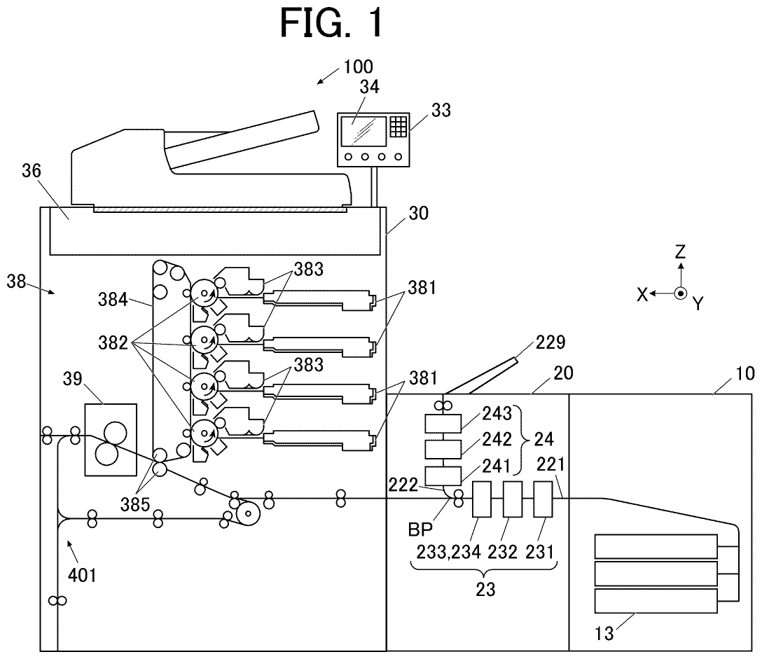

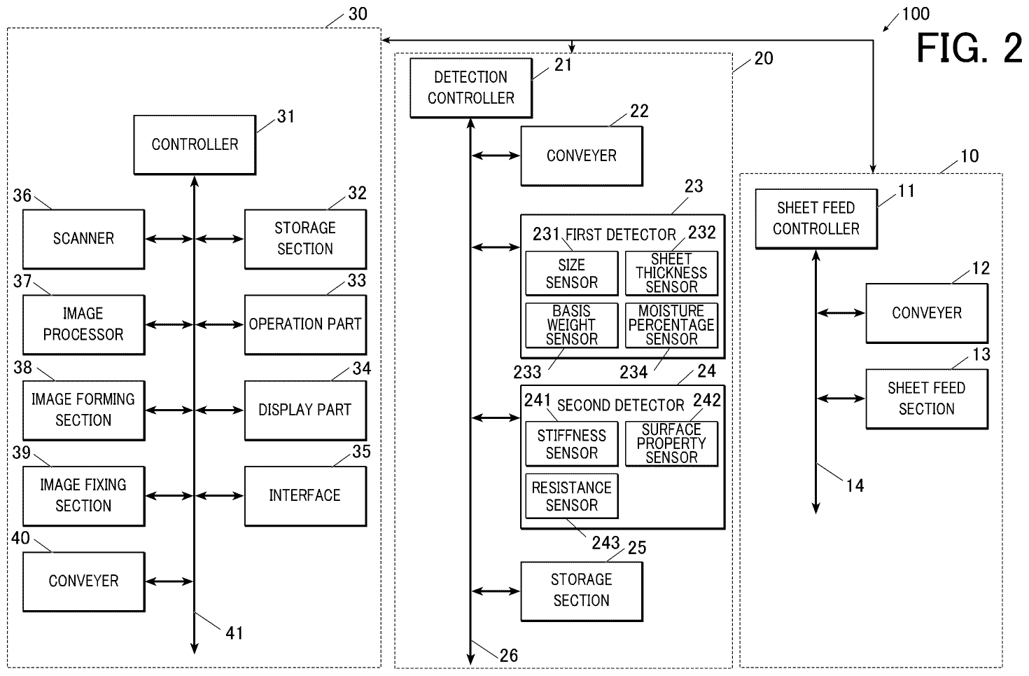

FIG. 1 is a diagram illustrating a schematic configuration of an image forming system 100 according to the present embodiment. FIG. 2 is a block diagram illustrating a main functional configuration of the image forming system 100.

An image forming system 100 according to the present embodiment includes a sheet feed device 10, a detection device 20 which is a medium detection device (sheet type determination device), and an image forming apparatus 30.

In the image forming system 100, the sheet feed device 10, the detection device 20, and the image forming apparatus 30 are disposed in this order from the upstream in a conveyance direction of a sheet.

### [1-1. Configuration of Sheet Feed Device]

The sheet feed device 10 includes a sheet feed controller (hardware processor) 11, a conveyor 12, sheet feed sections 13, and the like.

The sheet feed controller 11 is coupled to the conveyor 12 and the sheet feed sections 13 via a bus 14.

The sheet feed controller 11 includes a central processing unit (CPU), a read only memory (ROM), and a random-access memory (RAM).

The CPU of the sheet feed controller 11 reads a program stored in the ROM, loads the program into the RAM, and centrally controls each component of the sheet feed device 10 in accordance with the loaded program.

For example, the sheet feed controller 11 conveys a sheet from a sheet feed tray of any one of the sheet feed sections 13 to the detection device 20 according to a job.

The conveyer 12 conveys a sheet through a conveyance path that connects the sheet feed sections 13 to the detection device 20.

The sheet feed sections 13 include sheet feed trays that store sheets according to predetermined paper types and sizes. Here, the sheet is a print medium on which an image can be formed in the image forming system 100 according to the present embodiment. The sheet includes various types of different printing media such as plain paper (common paper), synthetic paper, a transparent sheet, metallized paper, and colored paper.

### [1-2. Configuration of Detection Device]

The detection device 20 is disposed upstream of the image forming apparatus 30 in the sheet conveyance direction and detects a sheet conveyed from the sheet feed device 10.

The detection device 20 includes a detection controller (hardware processor) 21, a conveyer 22, a first detector 23, a second detector 24, and a storage section 25.

The detection controller 21 is coupled to the conveyer 22, the first detector 23, the second detector 24, and the storage section 25 via a bus 26.

The detection controller 21 includes a CPU, ROM, and RAM.

The CPU of the detection controller 21 reads a program stored in the ROM, loads the program into the RAM, and centrally controls each component of the detection device 20 in accordance with the loaded program.

For example, the detection controller 21 causes the first detector 23 and the second detector 24 to detect the sheet conveyed from the sheet feed device 10 or causes only the first detector 23 to detect the sheet.

The conveyer 22 includes a first conveyance path 221, a second conveyance path 222, and a purge tray 229 that ejects a sheet to be purged. The first and second conveyance paths 221 and 222 include a plurality of conveyance roller pairs disposed along the conveyance paths and drive motors (not illustrated) that drive the plurality of conveyance roller pairs. The first conveyance path 221 is a main conveyance path, and the upstream side is connected to a conveyance path of the sheet feed device 10 and the downstream side is connected to a conveyance path of the image forming apparatus 30. The second conveyance path 222 branches from the first conveyance path 221 at a branch point BP. In the second conveyance path 222, a sheet to be purged to the purge tray 229 is conveyed without passing through the image forming section 38. The first conveyance path 221 extends in a substantially horizontal direction. At least a portion of the second conveyance path 222 extends in a substantially vertical direction. In particular, in a region where a stiffness sensor 241 to be described later is disposed, the second conveyance path 222 extends in a substantially vertical direction, and the conveyance direction of the sheet is upward. Here, “substantially vertical” means that the angle is within a range of 90±1°. Note that the second conveyance path 222 may not be entirely straight. In the second conveyance path 222, if at least a measurement region of the stiffness sensor 241 is straight, other portions may be partially curved. For example, the second conveyance path 222 may be an S-shaped curved conveyance path as a whole.

The first detector 23 is disposed on the first conveyance path 221 and detects a sheet characteristic of a sheet to be conveyed in the first conveyance path 221 using the first conveyance path 221 as a detection region. In particular, the first detector 23 is disposed upstream of the branch point BP in the first conveyance path 221. The second detector 24 is disposed on the second conveyance path 222 downstream of the branch point BP.

The first detector 23 includes a size sensor 231, a sheet thickness sensor 232, a basis weight sensor 233, and a moisture percentage sensor 234.

The size sensor 231 optically detects the size (shape) of the sheet.

The size sensor 231 is a line sensor that reads a sheet being conveyed at a predetermined speed using the line sensor to generate read image data. The detection controller 21 performs image processing on the obtained read image data for one sheet to detect the edges (the positions of the four sides or the outer shape) and the size (shape) of the sheet.

The sheet thickness sensor 232 detects the thickness of a sheet by mechanically measuring the amount of displacement.

When the sheet is conveyed to the nip of the conveyance roller pair, the shaft position of one of the driven rollers of the conveyance roller pair changes according to the thickness of the sheet. By measuring the change in height of the shaft, the thickness of the sheet is measured.

The basis weight sensor 233 is a transmissive and reflective optical sensor that detects the basis weight of a sheet. The basis weight sensor 233 includes a light emitter and a light receiver. The basis weight sensor 233 detects the basis weight of the sheet by measuring the amount of attenuation (transmittance) of light transmitted through the sheet and the amount of reflected light (reflectance). The light emitter of the reflective optical sensor includes, for example, a blue light emitting diode (LED) to emit blue light, a green LED to emit green light, and a red LED to emit red light. Therefore, the basis weight sensor 233 can detect the color of the sheet based on the amount of reflected light of each light emitted by the blue LED, the green LED, and the red LED.

The moisture percentage sensor 234 is a reflective optical sensor that detects the moisture percentage of a sheet. The moisture percentage sensor 234 includes a first light emitter for irradiating the sheet with light at a wavelength of 1450 nm, which is absorbed by moisture, a second light emitter for irradiating the sheet with light at a wavelength of 1300 nm, which is not absorbed by moisture, and a light receiver. The moisture percentage sensor 234 measures the amount of light received by each of the first and second light emitters (amount of reflected light) and detects the moisture percentage of the sheet based on the ratio between the first amount of light received by the first light emitter and the second amount of light received by the second light emitter.

In the first conveyance path 221, the basis weight sensor 233 and the moisture percentage sensor 234 are disposed downstream of the sheet thickness sensor 232. The basis weight sensor 233 and the moisture percentage sensor 234 are disposed side by side at the same position in the conveyance direction (X direction) and at different positions in the width direction (Y direction) in the first conveyance path 221. In this manner, the overall length of the first detector 23 in the conveyance direction can be shortened, and the space can be reduced. In the first conveyance path 221, the size sensor 231 is disposed upstream of the other sensors. That is, the size sensor 231 is disposed upstream of the sheet thickness sensor 232, the basis weight sensor 233, and the moisture percentage sensor 234. Normally, before an image is transferred onto a sheet in the image forming section 38, the leading edge of the sheet is stopped to temporarily hold the sheet. By disposing the size sensor 231 upstream of the other sensors, the distance between the size sensor 231 and the image forming section 38 can be increased, thereby preventing the sheet from being stopped during detection of the size sensor 231.

The size sensor 231, the sheet thickness sensor 232, the basis weight sensor 233, and the moisture percentage sensor 234 detect sheet characteristic information such as a size, a sheet thickness, a basis weight, and a moisture percentage while conveying the sheet through the first conveyance path 221 without stopping the sheet. Thus, when a print job in which printing is continuously performed is executed, the first detector 23 can detect the sheet characteristic information of each of a plurality of sheets conveyed continuously.

That is, the first detector 23 can detect the sheet characteristic information of all the sheets. The sheet characteristic information on the size, the sheet thickness, and the basis weight is sheet characteristic information corresponding to the paper type (sheet type). The sheet characteristic information on the moisture percentage is sheet characteristic information corresponding to the condition change of the sheet.

In this way, the first detector 23 detects the sheet characteristic information corresponding to the sheet type of the sheet or the condition change of the sheet each time. This allows for proper detection of cases where the type of sheet loaded in the sheet feed tray is different from that in the print job settings, or where wrong sheets are mixed in the sheet bundle (mainly related to the basis weight, thickness, and size), as well as cases where the sheet condition changes during continuous printing, or where the sheet bundle includes sheets whose sheet condition is not uniform (mainly related to the moisture percentage). Then, as described later, when the detection device 20 detects an improper sheet by the first detector 23, the sheet is switched to a purge path (second conveyance path 222) to be conveyed and ejected to the purge tray 229. In this way, the improper sheet is not fed to the subsequent stage, and it is possible to prevent a jam or an image defect from occurring in the image forming apparatus 30.

The size sensor 231 is disposed on the most upstream side. In principle, the size sensor 231 cannot determine the size until the sheet passes through a detection position (imaging position). Therefore, the size sensor 231 needs to be disposed upstream of the image forming position of the image forming section 38 (more specifically, the stopping position at a registration roller) by the length of the longest sheet (for example, a long sheet of about 900 mm) that can be handled by the image forming system 100. Therefore, the size sensor 231 is disposed on the most upstream side of the first conveyance path 221.

The sheet thickness sensor 232 is disposed second from the upstream side. The detection device 20 first detects the thickness of the sheet, so that a measurement range (latitude), measurement condition, and the like can be appropriately set at the times of detection by the basis weight sensor 233 and the moisture percentage sensor 234 in the subsequent stage.

The second detector 24 includes a stiffness sensor 241, a surface property sensor 242, and a resistance sensor 243.

The stiffness sensor 241 detects the stiffness of a sheet by mechanically measuring the amount of displacement. The stiffness sensor 241 detects the stiffness of a sheet based on a repulsive force (stiffness) of the sheet when a presser (not shown) presses a lower end (free end) of the sheet from a side direction.

The surface property sensor 242 is a reflective optical sensor (specular reflection and diffuse reflection) that detects the surface property of a sheet. The surface property sensor 242 detects the surface property of a sheet based on the absolute values of the intensities of the detected specular reflection light and diffuse reflection light and the ratio.

The resistance sensor 243 applies a high voltage between the front and back of a sheet in a stopped state and detects the electrical resistance (volume electrical resistance) of the sheet based on the value of the flowing current.

In the second conveyance path 222, the stiffness sensor 241 and the surface property sensor 242 are disposed upstream (below) of the resistance sensor 243. Note that in the example illustrated in FIG. 1, the stiffness sensor 241 and the surface property sensor 242 are disposed in this order in the conveyance direction (Z direction), but this order can be reversed. Furthermore, for the reasons described below, the size sensor 231 is disposed in the path leading from the first conveyance path 221 to the second conveyance path 222 upstream of the moisture percentage sensor 234.

At the time of detection, the resistance sensor 243 applies a high voltage to the sheet to cause a current to flow through the sheet. Therefore, electric charges may be accumulated on the surface of the sheet after the resistance is detected, and the sheet may become electrostatically charged (especially in a low humidity environment).

Since there is a risk that the stiffness detection cannot be accurately performed with an electrostatically charged sheet, the stiffness sensor 241 is disposed upstream (below) of the resistance sensor 243. Furthermore, applying an electric current to the sheet at the time of detection by the resistance sensor 243 may slightly heat the sheet, thereby changing the moisture percentage. In order to eliminate this influence, the moisture percentage sensor 234 is disposed upstream of the resistance sensor 243 (in the first conveyance path 221).

The second detector 24 stops the sheet at each sensor position to perform detection and sends the sheet to the next sensor downstream. The next sensor performs measurement in a state in which the rear end of the sheet is not nipped by the constituent members (rollers or the like) of the previous sensor. By leaving the end open, it becomes easier to press the sheet for surface fixation by the constituent member of the sensor. When the sheet is sufficiently long (in the conveyance direction), for example, when the sheet is longer than the A4 size, the sheet can be placed across the detection positions of the three sensors. Therefore, the second detector 24 can simultaneously perform the resistance detection by the resistance sensor 243, the surface property detection by the surface property sensor 242, and the stiffness detection by the stiffness sensor 241 in a single stop, minimizing a decrease in productivity.

The storage section 25 includes a storage means such as dynamic random access memory (DRAM), which is a semiconductor memory, and/or a hard disk drive (HDD).

The storage section 25 stores a first threshold value used in sheet type determination processing to be described later, a linear function formula for calculating a second threshold value, and a third threshold value.

### [1-3. Configuration of Image Forming Apparatus]

The image forming apparatus 30 forms a color image according to an electrophotographic method based on image data obtained by reading an image from an original document or image data of a job received from an external apparatus (not illustrated).

The image forming apparatus 30 includes a controller (hardware processor) 31, a storage section 32, an operation part 33, a display part 34, an interface 35, a scanner 36, an image processor 37, an image forming section 38, an image fixing section 39, a conveyer 40, and the like.

The controller 31 is coupled to the storage section 32, the operation part 33, the display part 34, the interface 35, the scanner 36, the image processor 37, the image forming section 38, the image fixing section 39, and the conveyor 40 via a bus 41.

The controller 31 includes a CPU, ROM, and RAM.

The CPU of the controller 31 reads a control program stored in the ROM, load the control program into the RAM, and centrally controls each component of the image forming apparatus 30 in accordance with the loaded program.

For example, the controller 31 causes the image processor 37 to perform predetermined image processing on image data and causes the storage section 32 to store the processed image data. Furthermore, the controller 31 causes the conveyor 40 to convey a sheet, and causes the image forming section 38 to form an image on the sheet based on the image data stored in the storage section 32.

The storage section 32 includes a storage means such as a DRAM, which is a semiconductor memory, and/or an HDD.

The storage section 32 stores image data acquired by the scanner 36, image data externally input through the interface 35, and the like. Note that this image data and the like may be stored in the RAM included in the controller 31. The storage section 32 stores a process condition estimation model used in process condition setting processing described later.

The operation part 33 includes input units such as operation keys and/or a touch screen disposed on top of a screen of the display part 34. The operation part 33 converts an input operation on these input units into an operation signal and outputs the operation signal to the controller 31.

The display part 34 includes a display such as a liquid crystal display (LCD). The display part 34 displays a state of the image forming system 100, an operation screen indicating content of an input operation on the touch screen, and the like.

The interface 35 is a means of transmitting and receiving data to and from an external computer, another image forming apparatus, or the like. The interface 35 includes any of various types of serial interfaces, for example.

The scanner 36 reads an image formed on a sheet, generates image data including single-color image data for each of R (red), G (green), and B (blue) color components, and stores the image data in the storage section 32.

The image processor 37 includes, for example, a rasterization processor, a color converter, a tone corrector, and a halftone processor. The image processor 37 performs various kinds of image processing on the image data stored in the storage section 32 and stores the processed image data in the storage section 32.

The image forming section 38 forms an image on a sheet based on the image data stored in the storage section 32. The image forming section 38 includes four subsections each including an exposure section 381, a photosensitive drum 382, and a developing section 383. The four subsections correspond to four color components of C (cyan), M (magenta), Y (yellow), and K (black), respectively. Furthermore, the image forming section 38 includes a transfer member 384 and secondary transfer rollers 385.

The exposure section 381 includes a laser diode (LD) as a light-emitting element. The exposure section 381 drives the LD based on image data and irradiates and exposes a charged photosensitive drum 382 with laser light to form an electrostatic latent image on the photosensitive drum 382.

The developing section 383 develops the electrostatic latent image formed on the photosensitive drum 382 by supplying toner (color material) of a predetermined color (any of C, M, Y, and K) onto the exposed photosensitive drum 382 by a charged developing roller.

Images (single-color images) respectively formed with the toner of C, M, Y, and K on the four respective photosensitive drums 382 corresponding to C, M, Y, and K are sequentially transferred from the photosensitive drums 382 onto the transfer member 384 in a superimposed manner. Thus, a color image having the color components of C, M, Y, and K is formed on the transfer member 384. The transfer member 384 is an endless belt wound around a plurality of transfer member conveyance rollers and rotates in accordance with rotations of the transfer member conveyance rollers.

The secondary transfer rollers 385 transfer the color image on the transfer member 384 onto the sheet fed from the sheet feed device 10. More specifically, the sheet and the transfer member 384 are nipped by a transfer nip section formed by a pair of secondary transfer rollers 385 being pressed against each other. Then, by applying a predetermined transfer voltage to the secondary transfer rollers 385, the toner forming the color image on the transfer member 384 is attracted to the side facing the sheet and transferred to the sheet.

The image fixing section 39 includes a fixing roller, a pressure roller, and the like. The image fixing section 39 performs fixing processing of fixing the toner to the sheet by heating and pressing the sheet to which the toner has been transferred.

The conveyor 40 includes a plurality of sheet conveyance rollers that conveys a sheet by rotating while nipping the sheet and conveys the sheet along a predetermined conveyance path.

The conveyor 40 includes a reversing mechanism 401. The reversing mechanism 401 reverses the front and back of the sheet on which the fixing processing has been performed by the image fixing section 39 and conveys the sheet to the secondary transfer rollers 385. In the image forming apparatus 30, when images are to be formed on both sides of a sheet, the sheet is reversed by the reversing mechanism 401, and the sheet is ejected after the images are formed on both sides. When an image is to be formed on only one side of a sheet, the sheet on which an image has been formed on one side is ejected without reversing the front and back of the sheet by the reversing mechanism 401.

In the present embodiment, the controller 31 of the image forming apparatus 30 integrally controls the entire image forming system 100, but the present invention is not limited thereto.

The detection controller 21 of the detection device 20 may integrally control the entire image forming system 100.

### [2. Operation of Image Forming System]

Next, an operation of the image forming system 100 will be described.

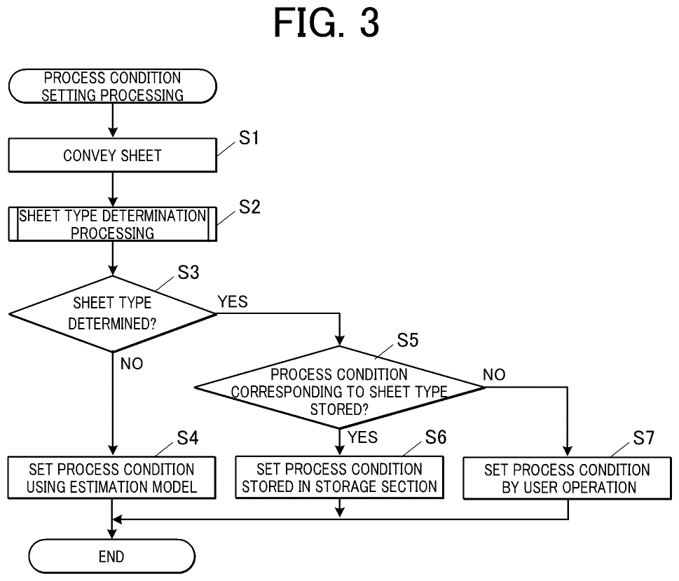

FIG. 3 is a flowchart illustrating a flow of process condition setting processing executed when the image forming apparatus 30 receives image data and setting information of a print job via the interface 35.

The process condition setting processing of FIG. 3 is executed by cooperation of the CPU of the controller 31 of the image forming apparatus 30 and a process condition control program stored in the ROM.

The controller 31 sets a process condition for image formation by the image forming section 38 for each determined sheet type by executing the process condition setting processing. Here, the process condition is, for example, a transfer condition when a color image on the transfer member 384 is transferred to a sheet. The transfer condition specifically includes a transfer voltage value and a transfer current value to be applied to the secondary transfer rollers 385 when a color image on the transfer member 384 is transferred to a sheet.

The controller 31 may set a process condition other than the transfer condition (for example, a fixing temperature when the fixing processing is performed by the image fixing section 39) by executing the process condition setting processing.

Further, the controller 31 may set a transfer condition other than the transfer voltage value and the transfer current value to be applied to the secondary transfer rollers 385 by executing the process condition setting processing.

### [2-1. Process Condition Setting Processing]

In the process condition setting processing, first, the controller 31 causes the sheet feed device 10 to feed a sheet on which an image is to be formed in a print job (a job target sheet) from the sheet feed section 13 and convey the sheet to the detection device 20 (step S1).

Next, the controller 31 causes the detection device 20 to perform sheet type determination processing on the job target sheet (step S2).

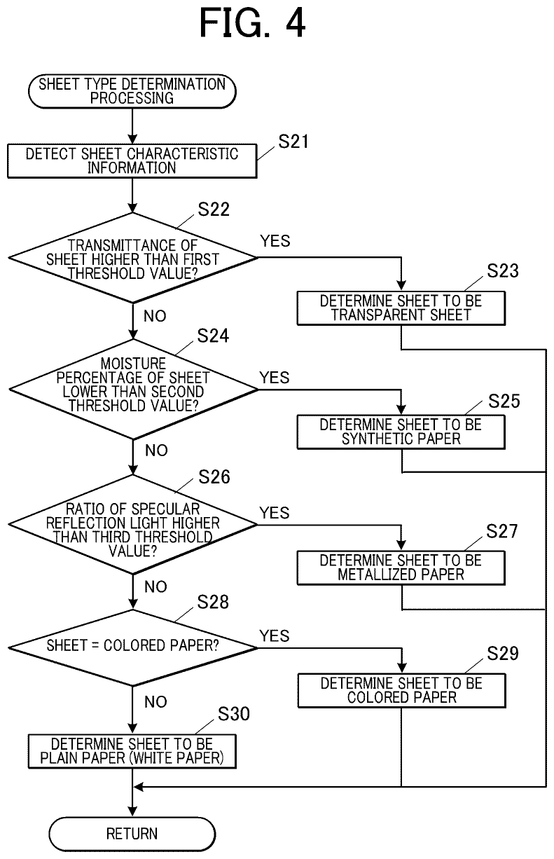

FIG. 4 illustrates a flowchart of the sheet type determination processing.

The sheet type determination processing of FIG. 4 is executed by cooperation of the CPU of the detection controller 21 and a sheet type determination program stored in the ROM.

### [2-2. Sheet Type Determination Processing]

First, the detection controller 21 detects sheet characteristic information (size, sheet thickness, basis weight, moisture percentage, stiffness, surface property, resistance, and the like) of the sheet on the first and second conveyance paths 221 and 222 by the first detector 23 and the second detector 24 (step S21). Here, the sheet characteristic information on the basis weight includes information on the amount of attenuation (transmittance) of light transmitted through the job target sheet and the amount of reflected light (reflectance) measured in the process of detecting the basis weight.

Next, the detection controller 21 determines, based on the detected sheet characteristic information, whether the amount of attenuation (transmittance) of light transmitted through the job target sheet is higher than the first threshold (step S22).

If, in step S22, it is determined that the amount of attenuation (transmittance) of light transmitted through the job target sheet is higher than the first threshold value (YES in step S22), the detection controller 21 determines the sheet type of the job target sheet to be a transparent sheet (step S23). Then, the detection controller 21 returns the processing to the process condition setting processing (see FIG. 3). Here, the transparent sheet is, for example, a transparent sheet made of resin, such as an overhead projector (OHP) sheet.

If, in step S22, it is determined that the amount of attenuation (transmittance) of light transmitted through the job target sheet is not higher than the first threshold value (NO in step S22), the detection controller 21 determines whether the moisture percentage of the job target sheet is lower than the second threshold value (step S24). Here, the second threshold value is calculated by the following linear function formula.

Second threshold value [%]=0.0113 (first constant)×sheet thickness [μm]+1.43 (second constant)

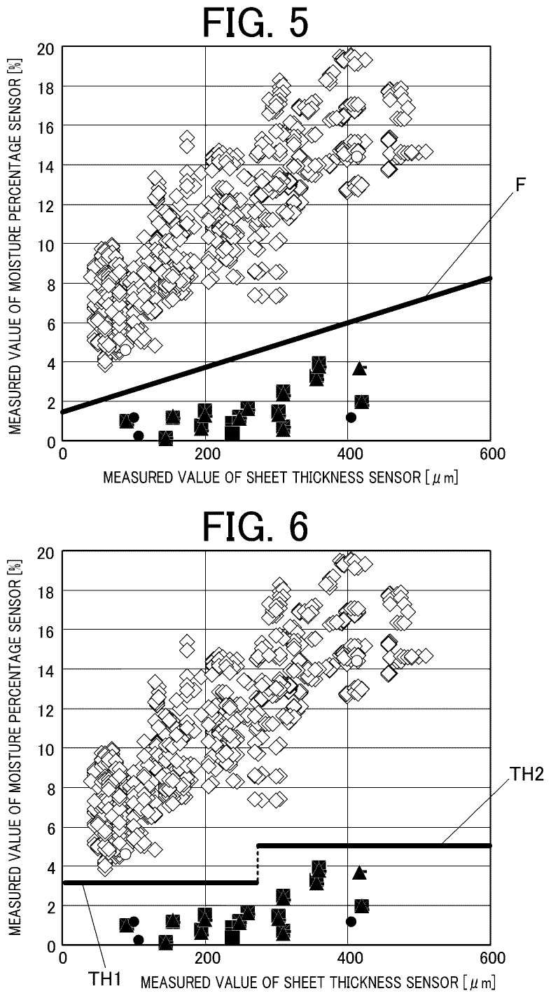

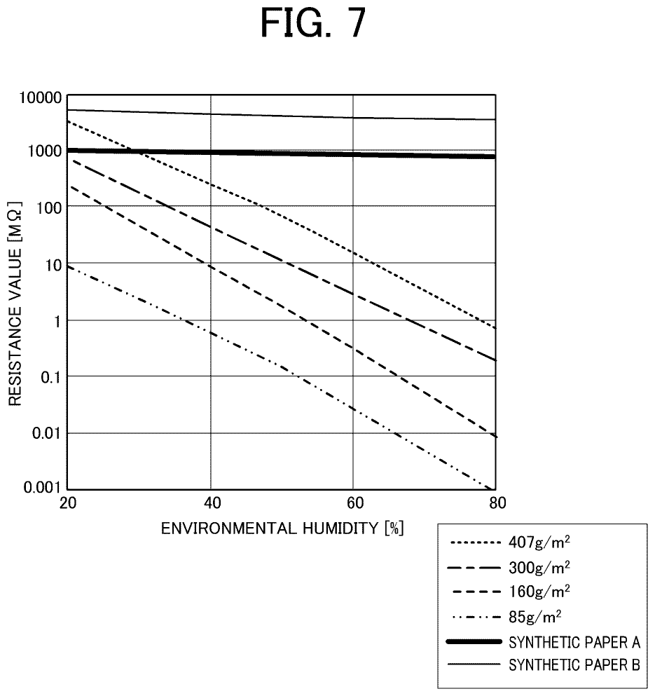

FIG. 5 is a diagram in which the above linear function formula is expressed in an xy coordinate system (indicated by reference numeral F in the diagram).

As illustrated in FIG. 5, in the xy coordinate system, the sheet thickness [μm] of the job target sheet is taken on the x-axis (horizontal axis), and the moisture percentage [%] of the job target sheet is taken on the y-axis (vertical axis). The sheet thickness [μm] and the moisture percentage [%] of actual data (sheet characteristic information) are plotted at corresponding coordinate positions. Among the plotted points, the points below the linear function formula F are those for synthetic paper. On the other hand, the points above the linear function formula F are those for paper made of pulp fiber (non-synthetic paper).

Note that a threshold value table in which the sheet thickness [μm] of the job target sheet is set as an input and the above-described second threshold value is set as an output may be stored in the storage section 25, and the second threshold value may be acquired using the threshold value table. Alternatively, as illustrated in FIG. 6, the second threshold value may be a predetermined fixed value. For example, the second threshold value may be a threshold value TH1 when the sheet thickness of the job target sheet is less than 280 μm, or a threshold value TH2 when the sheet thickness of the job target sheet is 280 μm or more. Note that the second threshold value may be a uniform value (fixed value) regardless of the sheet thickness of the job target sheet. Therefore, when the second threshold value is a uniform value, the detection controller 21 can determine whether the job target sheet is synthetic paper based on the detection result of the moisture percentage sensor (moisture sensor) 234 that detects the characteristic information (moisture percentage) corresponding to the moisture amount of the job target sheet.

Referring back to FIG. 4, if it is determined in step S24 that the moisture percentage of the job target sheet is lower than the second threshold value (YES in step S24), the detection controller 21 determines that the sheet type of the job target sheet is synthetic paper (step S25). Then, the detection controller 21 returns the processing to the process condition setting processing (see FIG. 3). Here, the synthetic paper is a sheet made of resin other than the transparent sheet described above, that is, a non-transparent sheet made of resin.

Furthermore, if it is determined in step S24 that the moisture percentage of the job target sheet is not lower than the second threshold value (NO in step S24), the detection controller 21 determines whether the ratio of the specular reflection light detected by the surface property sensor 242 is higher than the third threshold value (step S26).

If it is determined in step S26 that the ratio of the specular reflection light detected by the surface property sensor 242 is higher than the third threshold value (YES in step S26), the detection controller 21 determines that the sheet type of the job target sheet is metallized paper (step S27). Then, the detection controller 21 returns the processing to the process condition setting processing (see FIG. 3).

If it is determined in step S26 that the ratio of the specular reflection light detected by the surface property sensor 242 is not higher than the third threshold value (NO in step S26), the detection controller 21 determines whether the job target sheet is colored paper (step S28). Here, the detection controller 21 determines whether the job target sheet is colored paper based on the result of color detection performed by the basis weight sensor 233.

If it is determined in step S28 that the job target sheet is colored paper (YES in step S28), the detection controller 21 determines that the sheet type of the job target sheet is colored paper (step S29).

Then, the detection controller 21 returns the processing to the process condition setting processing (see FIG. 3).

If it is determined in step S28 that the job target sheet is not colored paper (NO in step S28), the detection controller 21 determines that the sheet type of the job target sheet is common plain paper (white paper) made of pulp fiber (step S30). Then, the detection controller 21 returns the processing to the process condition setting processing (see FIG. 3).

Referring back to FIG. 3, the controller 31 determines whether the sheet type of the job target sheet (transparent sheet, synthetic paper, metallized paper, colored paper, plain paper) has been determined in the sheet type determination processing of FIG. 4 (step S3).

In step S3, if it is determined that the sheet type of the job target sheet has not been determined (NO in step S3), the controller 31 sets a process condition estimated by the process condition estimation model stored in the storage section 32 (step S4). Then, the controller 31 ends the process condition setting processing. Here, the process condition estimation model is a learning model (learned model) obtained by machine learning based on learning data (learning information) including the sheet characteristic information. By inputting the sheet characteristic information (estimation information) of the job target sheet detected in step S21 of the sheet type determination processing (see FIG. 4) to the process condition estimation model, a process condition of the job target sheet can be estimated.

If it is determined in step S3 that the sheet type of the job target sheet has been determined (YES in step S3), the controller 31 determines whether a process condition corresponding to the sheet type of the job target sheet is stored in the storage section 32 (step S5).

If it is determined in step S5 that a process condition corresponding to the sheet type of the job target sheet is stored in the storage section 32 (YES in step S5), the controller 31 sets the process condition (step S6). Then, the controller 31 ends the process condition setting processing.

In step S5, if it is determined that a process condition corresponding to the sheet type of the job target sheet is not stored in the storage section 32 (NO in step S5), the controller 31 sets a process condition input by a user via the operation part 33 (step S7). Then, the controller 31 ends the process condition setting processing.

### [3. Effects]

As described above, the detection device (sheet type determination device) 20 according to the present embodiment is capable of determining whether a sheet is synthetic paper based on the detection result of the moisture sensor (moisture percentage sensor 234) detecting the characteristic information (moisture percentage) corresponding to the moisture amount of the sheet (job target sheet).

Thus, it is possible to determine whether a sheet is synthetic paper without being affected by environmental humidity. Therefore, it is possible to accurately distinguish between synthetic paper and common paper.

The detection device 20 determines whether a sheet is synthetic paper based on the detection result of the sheet thickness sensor (thickness sensor) 232 that detects the thickness of the sheet (job target sheet) and the detection result of the moisture percentage sensor (moisture sensor) 234.

Thus, whether a sheet is synthetic paper is determined in consideration of the detection result of the sheet thickness sensor 232. This makes it possible to more accurately distinguish between synthetic paper and common paper.

The detection device 20 determines whether a sheet is synthetic paper based on the detection result of the basis weight sensor 233 that detects the basis weight of the sheet (job target sheet) and the detection result of the moisture percentage sensor 234.

Thus, whether a sheet is the synthetic paper is determined in consideration of the detection result of the basis weight sensor 233. This makes it possible to more accurately distinguish between the synthetic paper and the common paper.

The detection device 20 determines a threshold value (second threshold value) used for determining whether a sheet is the synthetic paper based on the detection result of the sheet thickness sensor 232.

As a result, when whether a sheet is synthetic paper is determined, a threshold value (second threshold value) based on the detection result of the sheet thickness sensor 232 can be used. This makes it possible to more accurately distinguish between the synthetic paper and the common paper.

The detection device 20 determines that the sheet is non-synthetic paper including a sheet made of pulp fiber when the detection result of the moisture percentage sensor 234 is higher than the threshold value (second threshold value). The detection device 20 determines that the sheet is synthetic paper made of resin when the detection result is lower than the threshold value.

Thus, it is possible to accurately distinguish between synthetic paper and common paper.

The detection device 20 determines the threshold value (second threshold value) using the following calculation formula (linear function formula). Second threshold value=0.0113 (first constant)×sheet thickness [μm]+1.43 (second constant)

As a result, when whether a sheet is synthetic paper is determined, a threshold value (second threshold value) based on the detection result of the sheet thickness sensor 232 can be used. This makes it possible to more accurately distinguish between the synthetic paper and the common paper.

The detection device 20 further determines, based on the detection result (detection result of the basis weight sensor 233) about characteristic information corresponding to the transmittance of the light emitted on the sheet (the job target sheet), whether the sheet is a transparent sheet.

As a result, it is possible to determine whether a sheet is synthetic paper, and if the sheet is synthetic paper, whether the sheet is a transparent sheet.

The image forming system 100 according to the present embodiment changes the secondary transfer current (transfer current value applied to the secondary transfer roller 385) to be applied to the sheet (the job target sheet) in the image forming section 38 based on the determination result of the sheet type by the detection device (the sheet type determination device) 20.

Thus, since the secondary transfer current can be adjusted in accordance with the sheet, it is possible to suitably form an image on the sheet.

The sheet type determination program according to the present embodiment can cause the computer (detection device 20) to function as a determination means that determines whether a sheet is synthetic paper based on the detection result of the moisture sensor (moisture percentage sensor 234) that detects characteristic information (moisture percentage) corresponding to the moisture amount of the sheet (job target sheet).

Thus, it is possible to determine whether a sheet is synthetic paper without being affected by environmental humidity. Therefore, it is possible to accurately distinguish between synthetic paper and common paper.

The description in the above embodiment is an example of the sheet type determination device, the image forming system, and the sheet type determination program according to the present invention and is not limited thereto. The detailed configuration and detailed operation of the components constituting the apparatuses can be changed as appropriate without departing from the scope of the present invention.

In addition, in the above-described embodiment, the sheet type determination device (detection device 20) is applied to the image forming apparatus 30 of which the printing method is an electrophotographic method, but the present invention is not limited thereto. The sheet type determination device can be applied to an image forming apparatus of an inkjet method or an image forming apparatus of another printing method. Although embodiments of the present invention have been described and shown in detail, the disclosed embodiments are made for purposes of illustration and example only and not limitation. The scope of the present invention should be interpreted by terms of the appended claims.

What is claimed is:

1. A sheet type determination device for determining a sheet type, comprising a hardware processor that determines whether a sheet is synthetic paper based on a detection result of a moisture sensor configured to detect characteristic information corresponding to a moisture amount of the sheet.

2. The sheet type determination device according to claim 1, wherein the hardware processor determines whether the sheet is synthetic paper based on a detection result of a thickness sensor configured to detect a thickness of the sheet and the detection result of the moisture sensor.

3. The sheet type determination device according to claim 1, wherein the hardware processor determines whether the sheet is synthetic paper based on a detection result of a basis weight sensor configured to detect a basis weight of the sheet and the detection result of the moisture sensor.

4. The sheet type determination device according to claim 2, wherein the hardware processor determines, based on the detection result of the thickness sensor, a threshold value that is used for determining whether the sheet is synthetic paper.

5. The sheet type determining device according to claim 4, wherein
when the detection result of the moisture sensor is higher than the threshold value, the hardware processor determines the sheet to be non-synthetic paper including a sheet made of pulp fiber, and
when the detection result of the moisture sensor is lower than the threshold value, the hardware processor determines the sheet to be synthetic paper made of resin.

6. The sheet type determination device according to claim 4, further comprising a threshold value table in which an input is the thickness of the sheet, and an output is the threshold value.

7. The sheet type determination device according to claim 4, wherein the hardware processor determines the threshold value by a calculation formula,
the threshold value=the thickness of the sheet×a first constant+a second constant.

8. The sheet type determination device according to claim 1, wherein the hardware processor determines whether the sheet is a transparent sheet based on a detection result about characteristic information corresponding to transmittance of light emitted on the sheet.

9. An image forming system comprising the sheet type determination device according to claim 1, wherein a secondary transfer current to be applied to the sheet in an image forming section is changed based on the sheet type determined by the sheet type determination device.

10. An image forming system comprising the sheet type determination device according to claim 1, wherein a fixing temperature for fixing toner to the sheet in an image forming section is changed based on the sheet type determined by the sheet type determination device.

11. A non-transitory recording medium storing a computer-readable program, the program causing a computer to determine whether a sheet is synthetic paper based on a detection result of a moisture sensor configured to detect characteristic information corresponding to a moisture amount of the sheet.
